(19) United States
(12) Patent Application Publication
(10) Pub. No.: US 2013/0139482 A1
(43) Pub. Date: Jun. 6, 2013

(54) STRUCTURE OF DUST COLLECTOR

(71) Applicant: CHUN-HSIANG WANG, Taichung City (TW)

(72) Inventor: CHUN-HSIANG WANG, Taichung City (TW)

(21) Appl. No.: 13/563,754

(22) Filed: Aug. 1, 2012

(30) Foreign Application Priority Data
Dec. 6, 2011 (TW) 100222993

(51) Int. Cl. B01D 46/00

(52) U.S. Cl. 55/471

(57) ABSTRACT

A dust collector includes a housing and a case. The housing forms therein an air chamber in which filter cylinders are mounted. The case has an interior space divided by a separation board into an air inlet compartment communicating the air chamber of the housing and an air outlet compartment communicating the air inlet compartment. A blower unit is mounted to the separation board and includes blast box mounted to the separation board in the air inlet compartment and a motor arranged in the air outlet compartment in such a way that an output spindle of the motor extending into the blast box and carrying a blade assembly. With such an arrangement, resonance caused by wind shear sound of the blade assembly is eliminated. Heat generated by the operation of the motor can be removed by air flow passing through the air outlet compartment to realize cooling of the motor.

### (a) TECHNICAL FIELD OF THE INVENTION

The present invention generally relates to the technical field of dust collection devices, and more particularly to a structure of dust collector with excellent silencing and cooling effect for improving the performance thereof, reducing the chance of breakdown of the dust collector, and suppress the generation of noise.

### (b) DESCRIPTION OF THE PRIOR ART

Dust collectors have wide applications for household and industry. The dust collector functions to collect powder dust generated at a specific site or a specific machine that works on a workpiece, such as lumber mill, metal workshop, and powder processing shop, in order to suppress potential risk of environmental pollution caused by the powder dusts or to facilitate subsequent processing operations of the workpiece. A conventional dust collector comprises a housing that forms therein an air chamber. In other words, the housing forms therein an air chamber in which a filter cylinder is arranged to filter off the powder dusts floating in air. In addition, a blower unit is arranged by the housing of the dust collector. The blower comprises a blade assembly that is arranged inside the housing and a motor installed outside the housing for driving purposes. The housing also forms therein an interconnected air conduction circuit. When the motor of the blower unit drives the blade assembly to operate, a suction force is induced to draw air that contains the powder dusts into the air chamber of the housing. The air is filtered by the filter cylinder and power dusts are allowed to fall into a dust collection barrel. The air that is so filtered is then released to the surroundings.

The blade assembly of the blower unit is mounted in the air conduction circuit of the housing. However, the air conduction circuit is generally of a large space. Before being completely expelled, air may be excited to form an airflow that may induce turbulences. As such, wind shears may be induced to cause resonance that leads to noise. When an operator is working in such a noisy environment for an excessively long period of time, occupational hazards may easily result.

Further, the motor of the blower unit is installed outside the housing. After a long term of operation, the motor may generate a great amount of heat. However, the blower unit generally not provided with a cooling system. Consequently, such a great amount of heat is generated dissipated away through surrounding air and the reduction of temperature is generally very inefficient. The motor, after being in operation in such a condition for a long while, may get damaged. This reduces the performance of the motor and also causes a waste of energy. Further, damage of components/parts may result. Apparently, further improvement is desired.

The present invention aims to provide a structure of dust collector that eliminates the above discussed problems and drawbacks.

### SUMMARY OF THE INVENTION

Thus, the primary object of the present invention is to provide a structure of dust collector with a silencing effect, whereby resonance generated by a blower unit due to wind shear sound and flow rate is eliminated so as to reduce the noise level of the working environment and prevent the occurrence of occupational hazards.

The secondary object of the present invention is to provide a structure of dust collector with a cooling effect, whereby a large amount of heat generated by the operation of blower unit can be efficiently dissipated to realize protection against loss caused by the heat and thus improving the operation efficiency and extending the life span thereof.

To achieve the above objects and the performance of the present invention, the following technical solution is adopted in the present invention, which at least comprises:

a housing, which forms therein an air chamber that receives therein a plurality of filter cylinders, the housing having a top forming a piping box;

a case, which is arranged at one side of the housing and comprises a vertical separation board mounted in an interior space thereof, so that the interior space of the case is divided by the separation board into an air inlet compartment and an air outlet compartment, in which the air inlet compartment corresponds to the piping box and communicates with interior of the housing and the air inlet compartment has a middle portion in which a horizontal separation board that forms a plurality of through holes is received and mounted, a channel being defined below the separation board, the case forming an air outlet opening in a top end of the air outlet compartment for discharging air outside; and

a blower unit, which is arranged above the separation board of the case, the blower unit comprising a blast box, a motor, and a blade assembly, wherein the blast box is fixed between the separation board and the horizontal separation board of the case, the blast box having a side surface forming an air draw-in hole and a bottom forming an air discharge hole corresponding to the through holes of the horizontal separation board, the motor being mounted to the separation board to correspond to the blast box and having an output spindle rotatably extending into the blast box, the blade assembly being mounted to the output spindle of the motor inside the blast box;

As such, through embodiment of the previously discussed technical solution of the present invention, the dust collector of the present invention may reduce the generation of noise caused by resonance of the blower unit due to wind shear noise of the blade assembly in blowing air. Further, the blower unit comprises a motor that is located in an air outlet compartment of a housing of the dust collector so that a discharge air flow may effectively remove thermal energy from the motor to realize cooling of the motor so that loss caused by high temperature may be eliminated and energy saving and improved performance can also be achieved. Further, since the heat generated by the operation of the motor can be efficiently removed, besides reducing consumption of energy and damage of components, the service life can also be extended to improve the added value of the product and increase economic value thereof.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a dust collector according to an embodiment of the present invention.

FIG. 2 is an exploded view showing a silencing mechanism according to the present invention.

FIG. 3 is another exploded view, taken at a different perspective, of the silencing mechanism of the present invention.

FIG. 4 is a perspective view showing the silencing mechanism of the present invention at said different perspective.

FIG. 5 is a side elevational view, partly broken, showing the dust collector according to the present invention.

FIG. 6 is an exploded view showing a silencing mechanism according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention provides a structure of dust collector. In an embodiment of the present invention, as well as components thereof, illustrated in the attached drawings, all references to “front”, “rear”, “left”, “right”, “top”, “bottom”, “up”, “down”, “horizontal” and “vertical” are provided for simplifying the description, not intending to impose any undue constraint to the present invention and not limiting any of the components in a specific site or direction. Sizes illustrated in the drawings and discussed in the specification are generally variable to suit the need of a specific embodiment of the present invention described herein without departing from the scope of the present invention.

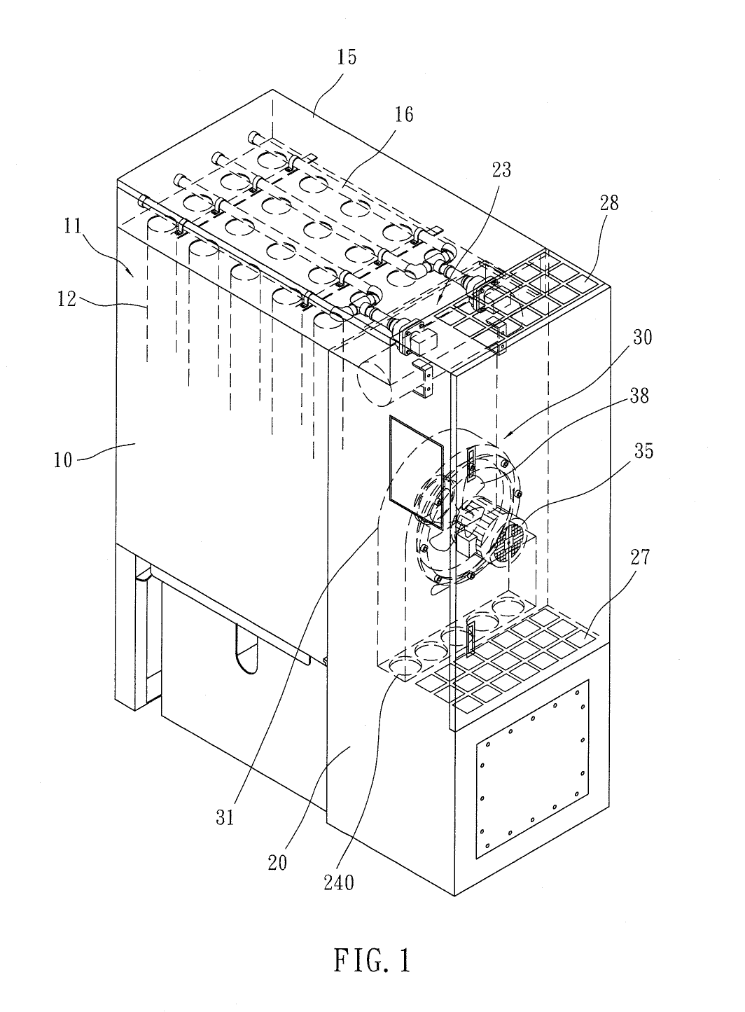

The structure of dust collector according to the present invention is shown in FIG. 1 and comprises a housing 10. The housing 10 forms therein an air chamber 11. The air chamber 11 receives therein a plurality of filter cylinders 12 mounted therein. The housing 10 has a top forming a piping box 15. The piping box 15 receives therein a plurality of air pipes 16 corresponding to the filter cylinders 12 of the air chamber 11 for blowing pressurized air into the corresponding filter cylinder 12 to blow off powder dusts attached to outer surfaces of the filter cylinders 12. Further, the housing 10 comprises a silencing mechanism arranged at one side thereof. The silencing mechanism comprises a case 20 of which an interior space communicates with the housing 10. The case 20 comprises a blower unit 30 mounted therein for blowing an intake air flow.

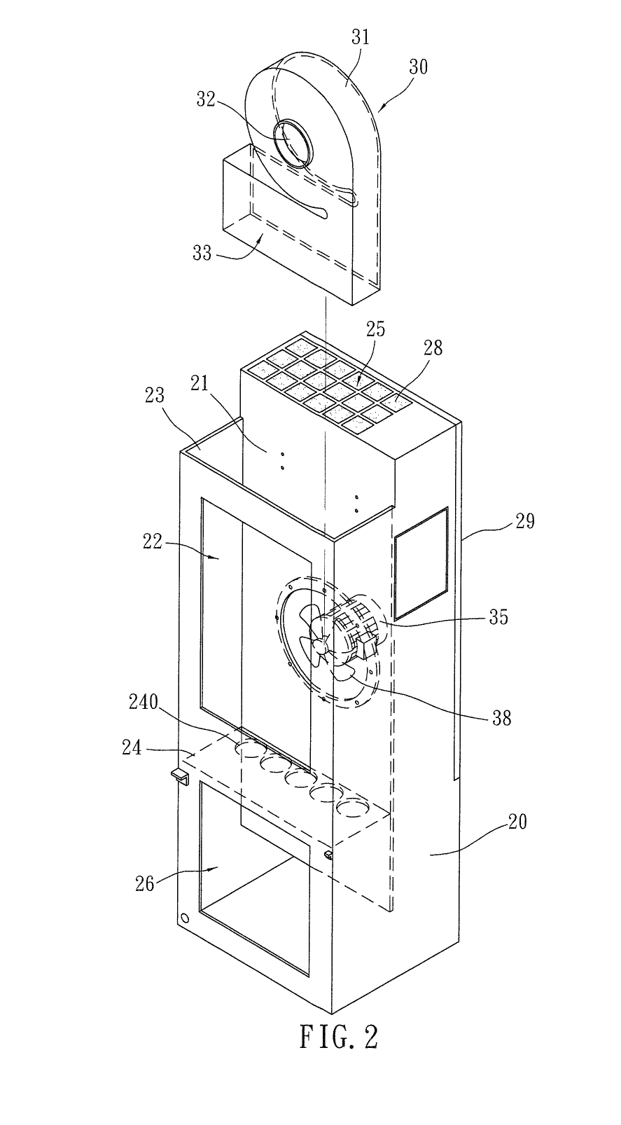

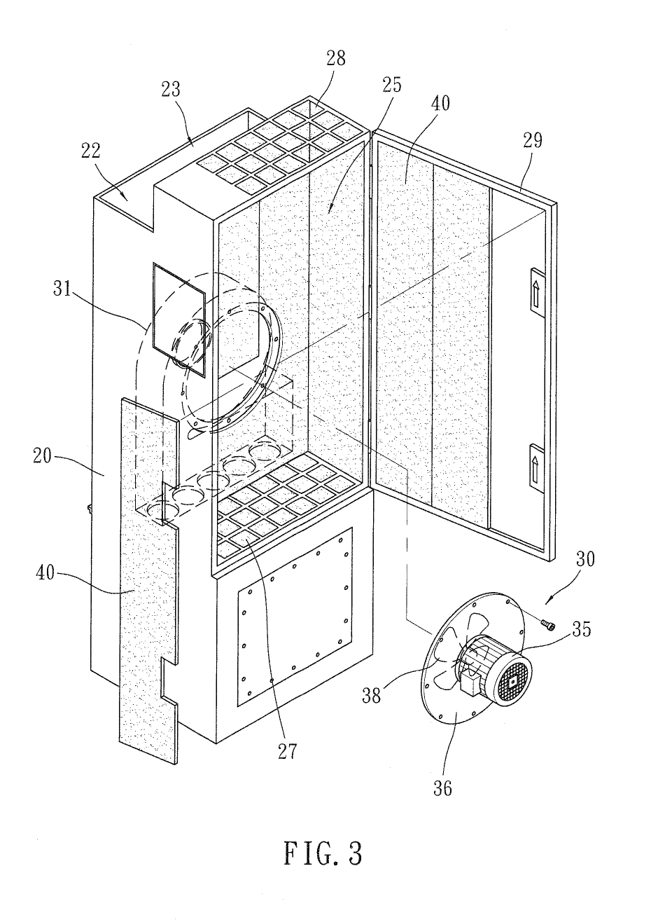

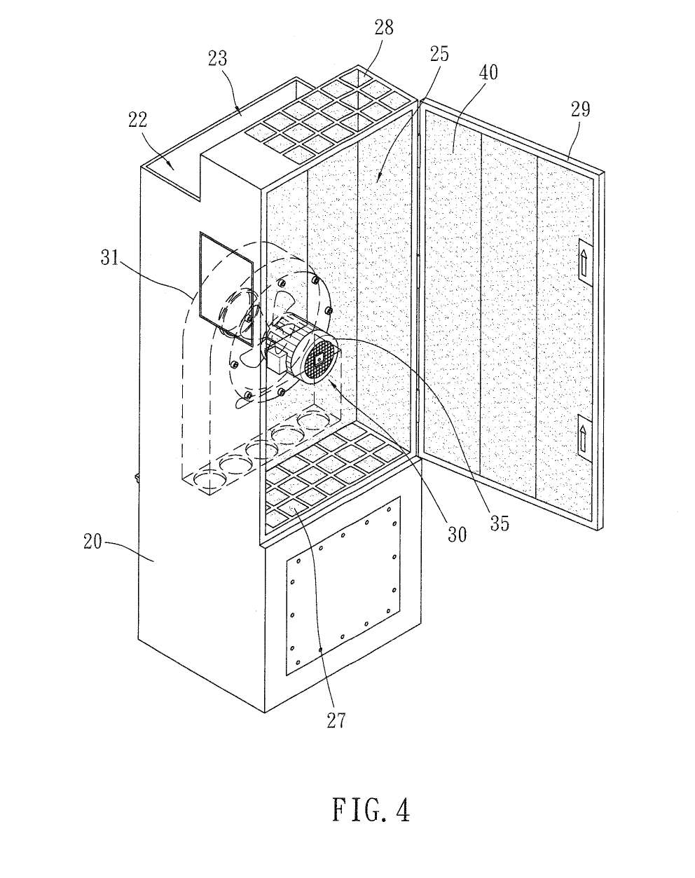

Further, for details of the structure of the silencing mechanism according to the present invention, reference is made to FIGS. 2, 3, 4, and 5, the case 20 comprises a vertical separation board 21 mounted therein. The case 20 has an interior space that is divided by the separation board 21 into an air inlet compartment 22 and an air outlet compartment 25. The air inlet compartment 22 has an air inlet opening 23 corresponding to the piping box 15 of the housing 10. The case 20 comprises a horizontal separation board 24 mounted at a middle portion thereof. The horizontal separation board 24 forming a plurality of through holes 240 corresponding to the air inlet compartment 22. The separation board 21 defines a channel 26 below the horizontal separation board 24 to allow the air inlet compartment 22 and the air outlet compartment 25 to communicate with each other. Further, the horizontal separation board 24 forms a plurality of air conduction holes 27 corresponding to the air outlet compartment 25. The case 20 forms air outlet openings 28 in a top end of the air outlet compartment 25 for discharging air into the outside. Further, the case 20 comprises a door panel 29 at an outer side thereof for selectively opening/closing the air outlet compartment 25 for maintenance and repairing operations. The case 20 comprises a plurality of sound-absorbing sponges 40 attached to inside surfaces of the air outlet compartment 25 and the door panel 29 for reducing resonant noise caused by air flowing therethrough.

Further, the blower unit 30 comprises a blast box 31, a motor 35, and a blade assembly 38. The blast box 31 is fixed to the separation board 21 of the case 20. The blast box 31 has a side surface forming an air draw-in hole 32. The blast box 31 has a bottom forming an air discharge hole 33 corresponding to the through holes 240 of the horizontal separation board 24. The motor 35 is mounted by a mounting board 36 to the separation board 21 at a location corresponding to the blast box 31. The motor 35 has an output spindle extending, in a rotatable manner, into the blast box 31 and the blade assembly 38 is mounted to the output spindle of the motor 35 that is received in the blast box 31, whereby the motor 35 drives the blade assembly 38 to rotate at a high speed to blow the intake air flow.

As such, a structure of dust collector that has a silencing effect and provides excellent heat dissipation performance is constructed.

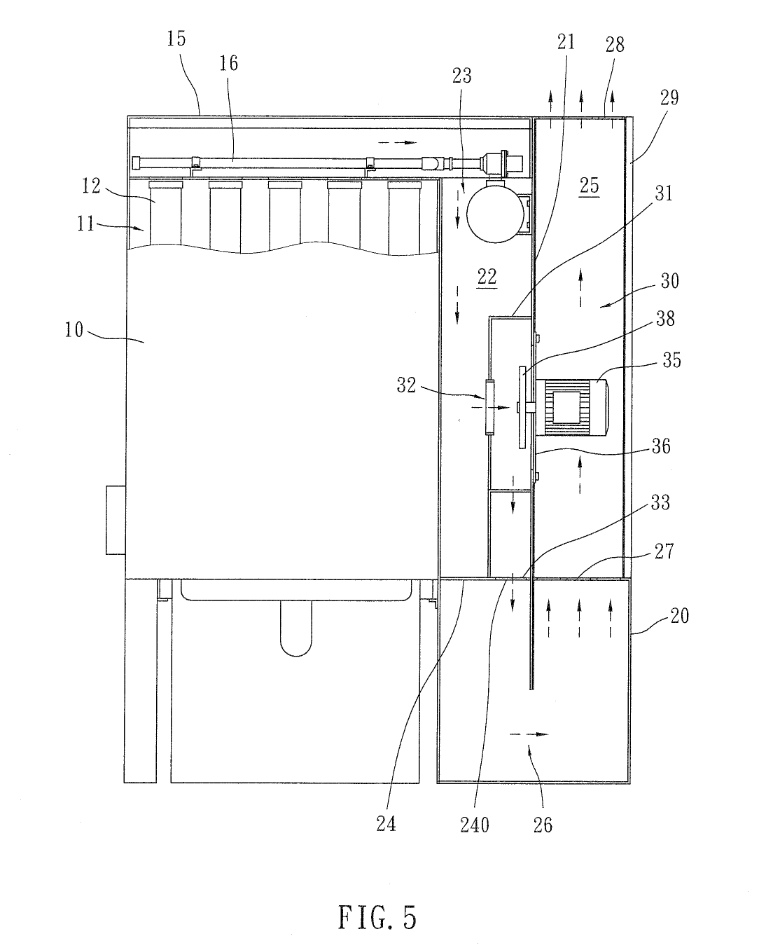

With the above described arrangement, in a practical application of the present invention, referring to FIG. 5, to operate, when the blower unit 30 of the dust collector is activated, the blade assembly 38 that is located in the blast box 31 is driven to blow an air flow, so that the surrounding air that contains powder dusts is drawn into the interior space of the air chamber 11 of the housing 10 and after being filtered by the filter cylinders 12, cleaned air is supplied from the filter cylinders 12, through the piping box 15, into the air inlet compartment 22 of the case 20. Since the blade assembly 38 is arranged in the blast box 31, the air is drawn through the air draw-in hole 32 into the blast box 31 and is discharged through the air discharge hole 33 and the through holes 240 of the horizontal separation board 24 into the space in a lower portion, where the air flow is guided by the channel 26 of the separation board 21 and the air conduction holes 27 of the horizontal separation board 24 to travel through the air outlet compartment 25 and then discharged outside through the air outlet openings 28.

As mentioned above, since the blade assembly 38 of the blower unit 30 is arranged inside the blast box 31, it does not causes any turbulence in the air inside the air inlet compartment 22 of the case 20 so that resonant noise caused by air turbulence can be greatly reduced. Further, with the arrangement of the sound-absorbing sponges 40 on the inside surfaces of the air outlet compartment 25 and the door panel 29, the noise caused by wind shear and high speed air flow induced by the blade assembly 38 can be minimized to thereby effectively improve working environment and reduce the potential risk of occupational hazards.

Further, since the discharged air flow moves from the lower side to the upper side and passes through the air outlet compartment 25 of the case 20 and since the motor 35 of the blower unit 30 is mounted in the air outlet compartment 25, the large amount of heat generated by the operation of the motor 35 can be instantly removed away by the air flow to realize cooling of the motor 35. As such, any loss of the motor 35 caused by the heat can be reduced thereby realizing energy saving and improvement of performance. Further, damage of components/parts is also reduced to effectively extend the life span thereof.

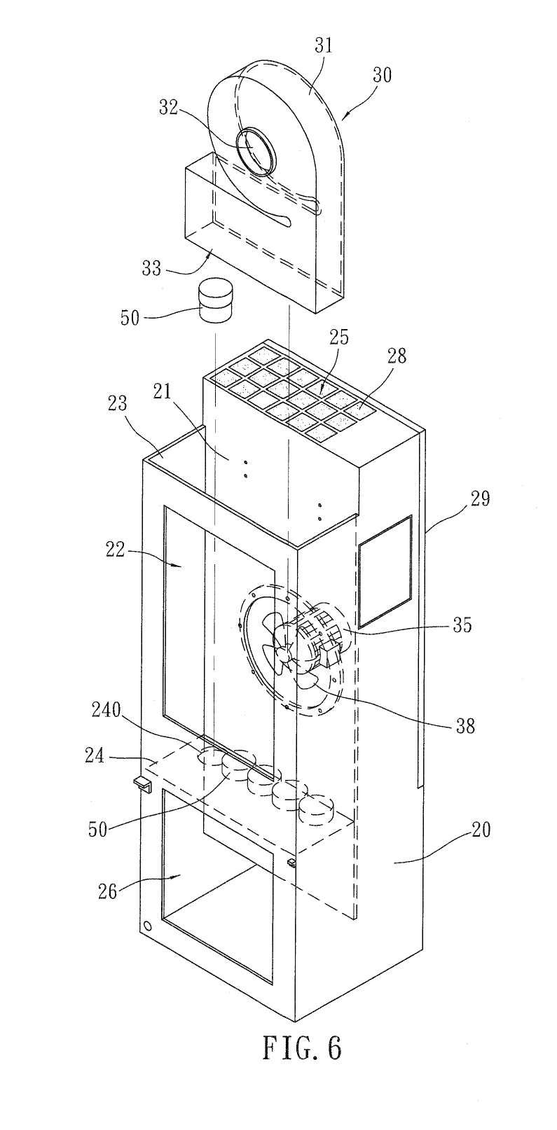

Further, another embodiment of the present invention is shown in FIG. 6, a sound silencer 50 is further mounted to the through holes 240 of the horizontal separation board 24 of the case 20. The sound silencer 50 is arranged on the through holes 240 through which air flow travels, so that friction sound of the air flow can be further suppressed to effectively reduce the level of noise thereof.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A dust collector, at least comprising:
a housing, which forms therein an air chamber that receives therein a plurality of filter cylinders, the housing having a top forming a piping box;
a case, which is arranged at one side of the housing and comprises a vertical separation board mounted in an interior space thereof, so that the interior space of the case is divided by the separation board into an air inlet compartment and an air outlet compartment, in which the air inlet compartment corresponds to the piping box and communicates with interior of the housing and the air inlet compartment has a middle portion in which a horizontal separation board that forms a plurality of through holes is received and mounted, a channel being defined below the separation board, the case forming an air outlet opening in a top end of the air outlet compartment for discharging air outside; and
a blower unit, which is arranged above the separation board of the case, the blower unit comprising a blast box, a motor, and a blade assembly, wherein the blast box is fixed between the separation board and the horizontal separation board of the case, the blast box having a side surface forming an air draw-in hole and a bottom forming an air discharge hole corresponding to the through holes of the horizontal separation board, the motor being mounted to the separation board to correspond to the blast box and having an output spindle rotatably extending into the blast box, the blade assembly being mounted to the output spindle of the motor inside the blast box;
whereby a dust collector featuring a silencing effect and showing excellent heat dissipation performance is formed.

2. The dust collector according to claim 1, wherein the piping box of the housing receives therein a plurality of air pipes corresponding to the filter cylinders located in the air chamber to supply pressurized air to the respective filter cylinders for blowing off power dust attached to outside surfaces of the filter cylinders.

3. The dust collector according to claim 1, wherein the horizontal separation board of the case extends into a middle portion of the air outlet compartment and a portion of the horizontal separation board that is located in the air outlet compartment forms a plurality of air conduction holes.

4. The dust collector according to claim 1, wherein the case comprises a door panel mounted to an outer side thereof to selectively open and close air outlet compartment for maintenance and repairing purposes.

5. The dust collector according to claim 1, wherein the case comprises a plurality of sound-absorbing sponges attached to inside surfaces of the air outlet compartment to reduce resonant noise caused by high speed air flow.

6. The dust collector according to claim 4, wherein the case comprises a plurality of sound-absorbing sponges attached to inside surfaces of the air outlet compartment and the door panel to reduce resonant noise caused by high speed air flow.

7. The dust collector according to claim 1, wherein the motor of the blower unit is mounted by a mounting board to a surface of the separation board.

8. The dust collector according to claim 1, wherein the case comprises a sound silencer mounted the through holes of the horizontal separation board in order to reduce noise.
